(19) United States
(12) Patent Application Publication
(10) Pub. No.: US 2004/0234449 A1
(43) Pub. Date: Nov. 25, 2004

(54) Method for controlling synthesis conditions during molecular sieve synthesis using combinations of quaternary ammonium hydroxides and halides

(76) Inventors: Gary Pasquale, Lansdale, PA (US); Ernest Senderov, Jamesburg, NJ (US)

Correspondence Address: ROBERT S. LIPTON, ESQUIRE, 201 NORTH JACKSON STREET, P. O. BOX 934, MEDIA, PA, 19063-0934, US

(21) Appl. No.: 10/869,306

(22) Filed: Jun. 16, 2004

Related U.S. Application Data
(63) Continuation of application No. 10/293,245, filed on Nov. 13, 2002, now abandoned.
(60) Provisional application No. 60/335,417, filed on Nov. 15, 2001.
(60) Provisional application No. 60/387,945, filed on Jun. 12, 2002.

(51) Int. Cl. C11D 17/00

(52) U.S. Cl. 423/707

(57) ABSTRACT

To control the pressure generated by the decomposition of quaternary ammonium hydroxides during the crystallization of molecular sieve materials at elevated temperatures, to levels below the mechanical limits of the equipment, the present invention substitutes halide salts of the same quaternary ammonium structure directing agent compound for some fraction of the hydroxide compound. In addition, because the quaternary ammonium hydroxides are generally more expensive than the corresponding halides, using a combination of the two reduces the cost of manufacturing the molecular sieve product.

### RELATED APPLICATIONS

The present application is a continuation application of U.S. application Ser. No. 10/293,245, filed Nov. 13, 2002 entitled “Method for Controlling Synthesis Conditions During Molecular Sieve Synthesis Using Combinations of Quaternary Ammonium Hydroxides and Halides” and a continuation-in-part of U.S. Application Ser. No 60/335,417, filed Nov. 15, 2001, entitled “Methods for Preparing Titanium-Silicate Molecular Sieves” and U.S. Application Ser. No. 60/387,945, filed Jun. 12, 2002, entitled “TS-PQ Titano-Silicate Molecular Sieves and Methods For Synthesis and Use Thereof.”

### FIELD OF THE INVENTION

Molecular sieve compounds, such as synthetic zeolites, are often synthesized using organic structure directing agents, such as quaternary ammonium compounds. At the relatively high temperatures used for efficient synthesis of these compounds, the organic structure directing agents tend to decompose, yielding high vapor pressure fragments. These decomposition products, in turn, can cause mechanical failure of the reaction vessels in which the synthesis is conducted, unless the reaction conditions are moderated to reduce the pressure, and such moderation, in turn, reduces the yield of the synthesis. The present invention comprises a method for reducing the pressure within the reaction vessel, while maintaining optimal yield of high-quality molecular sieve product.

### BACKGROUND OF THE INVENTION

The synthesis of zeolites such as ZSM-12 in the presence of an organic quaternary ammonium compound is well understood in the prior art. (U.S. Pat. No. 3,832,449 teaches the use of TEAOH, while U.S. Pat. No. 4,452,769 teaches the use of MTEAOH.) The decomposition of such compounds, via the Hofmann elimination reaction, to yield a high vapor pressure organic fraction (usually a mixture of alkenes and amines,) is also well understood in the prior art. The Hofmann elimination reaction is readily apparent when a quaternary ammonium hydroxide is heated to 125° C. or higher, (see Morrison & Boyd, Organic Chemistry, 2^{nd} edition, 1966, Allyn & Bacon, Inc., Boston, Mass., USA)

The pressure limit of zeolite synthesis equipment may be due to several factors, including valve type and construction, agitator and other seals, vessel materials and thickness, and the like. Prior art methods that have been used to reduce the pressure generated during a zeolite crystallization include lowering the operating temperature and/or significant reduction of the alkalinity of the reaction mixture. Both of these methods increase the time required to crystallize the desired zeolite and the risk of producing contaminated product. Another way to manage the high pressure resulting from the use of quaternary ammonium hydroxides is to increase the mechanical limit of the equipment, by installing better quality valves, agitator seals, pressure relief equipment, etc., and improving the structural integrity of the reactor. All of these prior art methods add significant cost to the manufacture of a zeolite.

### BRIEF DESCRIPTION OF THE INVENTION

To control the pressure generated by the decomposition of quaternary ammonium hydroxides during the crystallization of zeolites at elevated temperatures, to levels below the mechanical limits of the equipment, the present invention substitutes halide salts of the same quaternary ammonium compound for some fraction of the hydroxide compound. In addition, because the quaternary ammonium hydroxides are generally more expensive than the corresponding halides, using a combination of the two reduces the cost of manufacturing the zeolite product.

### DETAILED DESCRIPTION OF THE INVENTION

The present invention reduces the amount of the quaternary ammonium hydroxide in the zeolite synthesis reaction mixture and thus to some degree, the alkalinity of the mixture, in order to reduce the quantity of decomposition products, usually alkenes and amines, having high vapor pressures. These compounds contribute significantly to the total pressure developed during a zeolite crystallization. The quaternary ammonium halide substitutes do not decompose directly at neutral or lower pH. The dissociated cations derived from them may however, in the presence of the alkalinity required for zeolite synthesis, also partially convert to the above mentioned decomposition products. Their presence helps to ensure the purity of the final zeolite product by maintaining the proportion of quaternary ammonium cation in the reaction mixture.

The organic structure directing agent (SDA) may be any known directing agent for the specified molecular sieve structural type. The SDA is preferably selected from the group consisting of compounds containing quaternary ammonium cations. Hydroxides of those cations are preferable because, in addition to their SDA function, they provide a source of alkalinity. It is known in the art that many other base materials are effective in such reactions, but tetraethylammonium hydroxide (TEAOH) is preferred in the present invention for the synthesis of zeolite Beta and ZSM-12.

It has been found that complete substitution of the halide for the hydroxide species results in undesireable contamination of the product by another zeolite phase, due to a reduction of the alkalinity of the reaction mixture. Similarly, adding another source of alkalinity, such as sodium hydroxide, also causes a contaminant phase to grow.

The halide for hydroxide substitution of the present invention has been used in the synthesis of two different zeolites, Beta (BEA) at several different SiO₂/Al₂O₃ ratios, and ZSM-12 (MTW). Examples for each are presented herein, together with examples of failed synthesis attempts that illustrate the critical nature of the partial substitution of the hydroxide species with the halide species. In these examples we found that TEAOH may be used in combination with TEA-halide and/or halide salts, up to preferably about 70 mole percent substitution of halide for hydroxide.

In order to prepare ZSM-12 in a commercial reactor, a combination of (preferably) tetraethylammonium hydroxide (TEAOH) and tetraethylammonium bromide (TEABr) may be used to moderate the pressure. Based on the experience of the present inventors, it is expected that this technology may be extended to any molecular sieve materials that are typically prepared using a quaternary ammonium hydroxide reagent.

ZSM-12 Synthesis

The method of the present invention may be useful as an adjunct to a wide variety of synthetic methods known in the art. For example, the method of ZSM-12 synthesis disclosed in U.S. Pat. No. 3,832,449, which teaches the use of TEAOH, suggests that the use of TEABr and other TEA Halides may be practiced. One skilled in the art will recognize that the lower molecular weight halides (F and Cl) may be more corrosive, thus increasing the cost of reaction equipment, but may be employed in the method of the present invention. Similarly, one skilled in the art will recognize that higher molecular weight halogens may increase the mass that must be transported in the reaction, thus having a negative effect on kinetics without other substantial benefits, but may, nonetheless, be employed in the method of the present invention. One skilled in the art will also recognize that the examples in this patent that used halide compounds all were conducted at low temperature, 100° C., for very long times greater than 50 days. Such conditions are not economically viable on commercial scale. The present invention defines a preferred region of synthesis compositions where the subject zeolites are crystallized rapidly, in less than 5 days, in pure form and under conditions where the final pressures achieved are low and moreover realistic for commercial equipment.

Other organic structure directing agents known to be useful in the synthesis of ZSM-12, and which may be substituted with a fraction of halide for hydroxide according to the present invention include:

methyltriethylammonium (see U.S. Pat. No. 4,452,769);

dimethylpyridinium or pyrollidinium (see U.S. Pat. No. 4,391,785);

diethyldimethylammonium (see U.S. Pat. No. 4,552,739);

dibenzyldimethylammonium (see U.S. Pat. No. 4,636,373);

hexamethylimmonium (see U.S. Pat. No. 5,021,141); diquat-4, diquat-5 or diquat-6 (see U.S. Pat. No. 5,137,705); decamethonium (see U.S. Pat. No. 5,192,521).

Similarly, the following organic structure directing agents are known in the art as being useful in the synthesis of ZSM-12 and other MTW-type zeolites, CHZ5, Nu13, Theta3, TPZ-12 and may be partially substituted with halide species for the hydroxide: N-containing polymers, (PhCH₂)Me₃N, (PhCH₂)₂Me₂N, Et₂Me₂N, Benzyltrialkylammonium⁺, BzNR₃, Dibenzyldiethylammonium⁺. See R. Szostak, Handbook of Molecular Sieves, 1992, Van Nostrand Reinhold, NY, N.Y., USA)

Beta Synthesis

For the synthesis of zeolite Beta, the following organic structure directing agents may be halide-substituted according to the method of the present invention: TEAOH (see U.S. Pat. No. 3,308,069); Dibenzyldimethylammonium hydroxide (see U.S. Pat. No. 4,642,226).

Similarly, other known syntheses of Beta which quaternary ammonium halides or molecules which react to form such a halide can be improved economically by promoting faster syntheses at higher temperature if quaternary ammonium hydroxide is substituted in part for the quaternary halide. These include: quaternary ammonium TEABr+NH₄0H ( M. J. Eapen et al., Zeolites, v. 14, 1994, p.295); TEA-halide+diethanoleamine (see U.S. Pat. No. 5,139,759); TEACl (see WO 94/26663); Benzyldimethylamine+benzylhalide (Eur. Patent Appl. 149,846);

### EXAMPLES

The raw materials, and their nominal compositions and suppliers, used in the following examples are:

TEAOH solution—35% tetraethylammonium hydroxide aqueous solution, SACHEM, Inc.

TEABr solution—50% tetr aethylammonium bromide aqueous solution, SACHEM, Inc.

Sodium aluminate solution—23.4% Al₂O₃, 19.5% Na₂O aqueous solution, Southern Ionics, Inc.

Colloidal silica solution—40% SiO₂, 0.5% Na₂O, aqueous solution, Nyacol, Inc.

Alumina coated colloidal silica solution—4% Al₂O₃, 26% SiO₂ aqueous solution, ONDEO Nalco, Inc.

Aluminum sulfate powder—17.5% Al₂O₃,

Sodium silicate solution—28.7% SiO₂, 8.9% Na₂O aqueous solution, PQ Corporation

Precipitated silica—92.4% SiO₂, balance H₂O, PPG Industries, Inc.

Potassium hydroxide solution—45% KOH, balance H₂O

### Example 1

### Prior Art ZSM-12 Example

273 parts of the TEAOH solution were added to 215 parts of deionized water. To this solution, 7 parts of the sodium aluminate solution were added and the resulting solution was mixed well. 455 parts of the colloidal silica solution were added to the previous solution with sufficient mixing to keep the gel fluid. Finally, 50 parts of the alumina coated colloidal silica solution were added to the gel and the mixture was agitated for 30 minutes to homogenize the resulting gel. The molar composition of this mixture was 1.0 Al₂O₃/1.65 Na₂O/90 SiO₂/1080 H₂O/18 TEAOH. The mixture was placed in an agitated autoclave and heated to 160° C. After 72 hours at 160° C. the autoclave was cooled to ambient temperature. During the 72 hours at 160° C., the pressure in the autoclave rose continuously to about 500 psig. The product slurry was filtered and the solids were washed with 7000 parts of deionized water. The resulting filter cake was dried at 120° C. for 16 hours. X-ray diffraction analysis of the dried solids indicated it was pure ZSM-12. A sample of the dried solids was calcined in a static bed at 538° C. for 5 hours in air. The BET surface area of the calcined solids was measured to be 414 m²/g.

### Example 2

### Present Invention ZSM-12

134 parts of the TEAOH solution were added to 229 parts of deionized water. 5.5 parts of the sodium aluminate solution were added to the TEAOH solution along with 134 parts of the TEABr solution. The resulting solution was mixed well. To this solution was added 441 parts of the colloidal silica solution with good agitation to keep the resulting mixture fluid. Finally, 58 parts of the alumina coated colloidal silica solution were added to the gel and this mixture was stirred well for 30 minutes to make it homogeneous. The molar composition of this mixture was 1.0 Al₂O₃/1.5 Na₂O/90 SiO₂/1080 H₂O/9 TEAOH/9 TEABr so that the molar TEA⁺/SiO₂ was the same as in the prior art example. The molar OH⁻/SiO₂ was reduced to 0.133 compared to 0.237 for the mixture of the prior art example. The mixture was placed in an agitated autoclave and heated to 160° C. After 72 hours at 160° C. the autoclave was cooled to ambient temperature. The pressure rose continuously over the 72 hours at 160° C. to a final pressure of 330 psig. The product slurry was filtered and the solids were washed with 7000 parts of deionized water. The resulting filter cake was dried at 120° C. for 16 hours. X-ray diffraction analysis of the dried solids indicated it was pure ZSM-12. A sample of the dried solids was calcined in a static bed at 538° C. for 5 hours in air. The BET surface area of the calcined solids was measured to be 397 m²/g.

### Example 3

### Present Invention ZSM-12

104 parts of the TEAOH solution were added to 232 parts of deionized water. To this solution were added 5.5 parts of the sodium aluminate solution and 163 parts of the TEABr solution. The resulting solution was mixed well. 439 parts of the colloidal silica solution were added to the solution with good agitation to keep the mixture fluid. Finally, 57 parts of the alumina coated colloidal silica solution were added to the gel. The final mixture was homogenized for 30 minutes. The molar composition of this mixture was 1.0 Al₂O₃/1.5 Na₂O/90 SiO₂/1080 H₂O/7 TEAOH/11 TEABr so that the molar TEA⁺/SiO₂ was the same as in the prior art example. The molar OH⁻/SiO₂ was reduced to 0.111 compared to 0.237 for the mixture of the prior art example. The mixture was placed in an agitated autoclave and heated to 160° C. After 72 hours at 160° C. the autoclave was cooled to ambient temperature. The pressure rose continuously over the 72 hours at 160° C. to a final pressure of 315 psig. The product slurry was filtered and the solids were washed with 7000 parts of deionized water. The resulting filter cake was dried at 120° C. for 16 hours. X-ray diffraction analysis of the dried solids indicated it was pure ZSM-12. A sample of the dried solids was calcined in a static bed at 538° C. for 5 hours in air. The BET surface area of the calcined solids was measured to be 390 m²/g.

### Example 4

### Failed ZSM-12

To 283 parts of deionized water, 188 parts of the TEAOH solution were added. This was followed by 7.5 parts of the sodium aluminate solution and the resulting solution was mixed well. Next, 470 parts of the colloidal silica solution were added to the mixture with good agitation to keep the mixture fluid. Finally, 51 parts of the alumina coated colloidal silica solution were added to the gel and the resulting mixture was stirred for 30 minutes to homogenize it. The molar composition of this mixture was 1.0 Al₂O₃/1.65 Na₂O/90 SiO₂/1080 H₂O/12 TEAOH. The molar TEA⁺/SiO₂ of this mixture was 0.133, lower than the molar TEA⁺/SIO₂ of 0.2 for the prior art example. The molar OH⁻/SiO₂ of the mixture of this example was 0.17, again lower than the 0.237 of the prior art example. The mixture was placed in an agitated autoclave and heated to 160° C. After 72 hours at 160° C. the autoclave was cooled to ambient temperature. The pressure rose continuously over the 72 hours at 160° C. to a final pressure of 275 psig. The product slurry was filtered and the solids were washed with 7000 parts of deionized water. The resulting filter cake was dried at 120° C. for 16 hours. X-ray diffraction analysis of the dried solids indicated it was pure ZSM-12 and ZSM-5.

### Example 5

### Failed ZSM-12 Example with TEABr

To 542 parts of deionized water was added 12 parts of the aluminum sulfate powder and the aluminum sulfate was dissolved by mixing. 177 parts of the TEABr solution were added to the solution and the mixture was stirred. To this solution was added 78 parts of precipitated silica, which was evenly distributed by mixing. Finally, 191 parts of the sodium silicate solution were added to the slurry with good agitation to keep the gel fluid. This mixture was stirred for 30 minutes to homogenize the gel. The molar composition of this mixture was 1.0 Al₂O₃/10 Na₂O/100 SiO₂/2000 H₂O/20 TEABr. The molar TEA⁺/SiO₂ was 0.2, the same as in the prior art formulation. The molar OH⁻/SiO₂ was also 0.2 and was slightly lower than the 0.237 of the mixture of the prior art example. The mixture was placed in an agitated autoclave and heated to 160° C. After 72 hours at 160° C. the autoclave was cooled to ambient temperature. The product slurry was filtered and the solids were washed with 7000 parts of deionized water. The resulting filter cake was dried at 120° C. for 16 hours. X-ray diffraction analysis of the dried solids indicated it was pure ZSM-5 with no trace of ZSM-12.

### Example 6

### Prior Art 50 SiO₂/Al₂O₃ Beta Synthesis

307 parts of the TEAOH solution were added to 117 parts of deionized water followed by 27 parts of the sodium aluminate solution. The resulting solution was mixed well. Finally, 549 parts of the colloidal silica solution were added to the mixture with good agitation to keep the resulting gel fluid. The final mixture was homogenized for 30 minutes. This mix had a molar composition of 1.0 Al₂O₃/2.1 Na₂O/60 SiO₂/600 H₂O/12 TEAOH. The mixture was placed in an agitated autoclave and heated to 160° C. After 24 hours at 160° C. the autoclave was cooled to ambient temperature. The pressure in the autoclave rose continuously over the 24 hours at 160° C. to a final pressure of about 380 psig. The product slurry was filtered and the solids were washed with 7000 parts of deionized water. The resulting filter cake was dried at 120° C. for 16 hours. X-ray diffraction analysis of the dried solids indicated it was pure zeolite Beta. A sample of the dried solids was calcined in a static bed at 538° C. for 5 hours in air. The BET surface area of the calcined solids was measured to be 707 m²/g.

### Example 7

### Present Invention Example for 50 SiO₂/Al₂O₃ Beta

To 127 parts of deionized water were added 228 parts of the TEAOH solution and 26 parts of the sodium aluminate solution. The resulting solution was mixed well and 76 parts of the TEABr solution were added to it with more mixing. Finally, 543 parts of the colloidal silica solution were added to the previous solution with good agitation to keep the gel fluid. This final mixture was stirred well for 30 minutes to homogenize it. The molar composition of this mixture was 1.0 Al₂O₃/2.1 Na₂O/60 SiO₂/600 H₂O/9 TEAOH/3 TEABr. The molar TEA⁺/SiO₂ of this formulation is the same as for the prior art formulation while the molar OH⁻/SiO₂ was reduced to 0.22 as compared to 0.27 for the prior art example. The mixture was placed in an agitated autoclave and heated to 160° C. After 24 hours at 160° C. the autoclave was cooled to ambient temperature. The pressure in the autoclave rose continuously over the 24 hours at 160° C. to a final pressure of about 160 psig. The product slurry was filtered and the solids were washed with 7000 parts of deionized water. The resulting filter cake was dried at 120° C. for 16 hours. X-ray diffraction analysis of the dried solids indicated it was pure zeolite Beta. A sample of the dried solids was calcined in a static bed at 538° C. for 5 hours in air. The BET surface area of the calcined solids was measured to be 692 m²/g.

### Example 8

### Failed 50 SiO₂/Al₂O₃ Beta

237 parts of the TEAOH solution were added to 172 parts of deionized water along with 27 parts of the sodium aluminate solution. The solution was mixed well. Finally, 564 parts of the colloidal silica solution were added to the solution with good agitation to keep the gel fluid. The final gel was mixed for 30 minutes to make it homogeneous. The molar composition of this gel was 1.0 Al₂O₃/2.1 Na₂O/60 SiO₂/600 H₂O/9 TEAOH. The molar TEA⁺/SiO₂ of this formulation is 0.15 compared to 0.2 for the prior art formulation. The molar OH⁻/SiO₂ is also lower at 0.22 for this example compared to 0.27 for the prior art example. The mixture was placed in an agitated autoclave and heated to 160° C. After 24 hours at 160° C. the autoclave was cooled to ambient temperature. The product slurry waspfiltered and the solids were washed with 7000 parts of deionized water. The resulting filter cake was dried at 120° C. for 16 hours. X-ray diffraction analysis of the dried solids indicated it was zeolite Beta contaminated with ZSM-5.

### Example 9

### Prior Art 22 SiO₂/Al₂O₃ Beta

192 parts of the TEAOH solution were added to 130 parts of deionized water followed by 69 parts of the sodium aluminate solution. The resulting solution was mixed well. Finally, 609 parts of the colloidal silica solution were added to the mixture with good agitation to keep the resulting gel fluid. The final mixture was homogenized for 30 minutes. This mix had a molar composition of 1.0 Al₂O₃/1.77 Na₂O/25.6 SiO₂/230 H₂O/2.89 TEAOH. The mixture was placed in an agitated autoclave and heated to 160° C. After 48 hours at 160° C. the autoclave was cooled to ambient temperature. The pressure in the autoclave rose continuously over the 48 hours at 160° C. to a final pressure of about 350 psig. The product slurry was filtered and the solids were washed with 7000 parts of deionized water. The resulting filter cake was dried at 120° C. for 16 hours. X-ray diffraction analysis of the dried solids indicated it was pure zeolite Beta. A sample of the dried solids was calcined in a static bed at 538° C. for 5 hours in air. The BET surface area of the calcined solids was measured to be 648 m²/g.

### Example 10

### Present Invention 22 SiO₂/Al₂O₃ Beta

To 26 parts of deionized water were added 136 parts of the TEAOH solution, 49 parts of the sodium aluminate solution and 25 parts of the potassium hydroxide solution. The resulting solution was mixed well and 68 parts of the TEABr solution were added to it with more mixing. 553 parts of the colloidal silica solution were added to the previous solution with good agitation to keep the gel fluid. Finally, 143 parts of the alumina coated colloidal silica solution were added to the gel with continued good mixing. This final mixture was stirred well for 30 minutes to homogenize it. The molar composition of this mixture was 1.0 Al₂O₃/1.18 Na₂O/0.59 K₂O/25.6 SiO₂/205 H₂O/1.93 TEAOH/0.96 TEABr. The molar TEA⁺/SiO₂ of this formulation is the same as for the prior art formulation while the molar OH⁻/SiO₂ was reduced to 0.214 as compared to 0.251 for the prior art example. The mixture was placed in an agitated autoclave and heated to 160° C. After 48 hours at 160° C. the autoclave was cooled to ambient temperature. The pressure in the autoclave rose continuously over the 48 hours at 160° C. to a final pressure of about 200 psig. The product slurry was filtered and the solids were washed with 7000 parts of deionized water. The resulting filter cake was dried at 120° C. for 16 hours. X-ray diffraction analysis of the dried solids indicated it was pure zeolite Beta. A sample of the dried solids was calcined in a static bed at 538° C. for 5 hours in air. The BET surface area of the calcined solids was measured to be 730 m²/g.

### Example 11

### Failed 22 SiO₂/Al₂O₃ Beta

137 parts of the TEAOH solution were added to 71 parts of deionized water along with 74 parts of the sodium aluminate solution. The solution was mixed well and 68 parts of the TEABr solution were added with continued mixing. Finally, 650 parts of the colloidal silica solution were added to the solution with good agitation to keep the gel fluid. The final gel was mixed for 30 minutes to make it homogeneous. The molar composition of this gel was 1.0 Al₂O₃/1.77 Na₂O/25.6 SiO₂/205 H₂O/1.93 TEAOH/0.96 TEABr. The molar TEA⁺/SiO₂ of this formulation is the same as for the prior art formulation while the molar OH⁻/SiO₂ was reduced to 0.214 as compared to 0.251 for the prior art example. The mixture was placed in an agitated autoclave and heated to 160° C. After 48 hours at 160° C. the autoclave was cooled to ambient temperature. The product slurry was filtered and the solids were washed with 7000 parts of deionized water. The resulting filter cake was dried at 120° C. for 16 hours. X-ray diffraction analysis of the dried solids indicated it was mordenite.

### Example 12

### Failed 22 SiO₂/Al₂O₃ Beta with TEABr

To 429 parts of the TEABr solution were added 36 parts of the sodium aluminate solution and 18 parts of the potassium hydroxide solution. The resulting solution was mixed well. 410 parts of the colloidal silica solution were added to the previous solution with good agitation to keep the gel fluid. Finally, 106 parts of the alumina coated colloidal silica solution were added to the gel with continued good mixing. This final mixture was stirred well for 30 minutes to homogenize it. The molar composition of this mixture was 1.0 Al₂O₃/1.18 Na₂O/0.59 K₂O/25.6 SiO₂/250 H₂O/8.2 TEABr. The molar TEA⁺/SiO₂ of this formulation is 0.32 as compared to 0.113 for the prior art formulation while the molar OH⁻/SiO₂ was reduced to 0.138 as compared to 0.251 for the prior art example. The mixture was placed in an agitated autoclave and heated to 160° C. After 48 hours at 160° C. the autoclave was cooled to ambient temperature. The product slurry was filtered and the solids were washed with 7000 parts of deionized water. The resulting filter cake was dried at 120° C. for 16 hours. X-ray diffraction analysis of the dried solids indicated it was still amorphous.

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may he made in the details within the scope and range of equivalents of the claims and without departing from the spirit of the invention. The inventors further require that the scope accorded their claims be in accordance with the broadest possible construction available under the law as it exists on the date of filing hereof (and of the application from which this application obtains priority,) and that no narrowing of the scope of the appended claims be allowed due to subsequent changes in the law, as such a narrowing would constitute an ex post facto adjudication, and a taking without due process or just compensation.

We claim as our invention:

1. A method for synthesizing molecular sieve materials at temperatures in excess of about 125° C. using organic structure directing agents having a quaternary ammonium hydroxide group, comprising substituting an effective amount of a like organic structure directing agent in the quaternary ammonium halide form, for a predetermined fraction (but less than all) of the quaternary ammonium hydroxide, such that final pressure is reduced without substantially reducing the reaction temperature.

2. The method of claim 1 for synthesizing ZSM-12, wherein the organic structure directing agent is selected from hydroxides and halides of the group of TEA, MTEA, dimethylpyridinum. pyrollidinium, diethyldimethylammonium, dibenzyldimethylammonium, hexamethylammonium, diquat-4, diquat-5, diquat-6, decamethonium, N-containing polymers, (PhCH₂)Me₃N, (PhCH₂)₂Me₂N, Et₂Me₂N, benzyltrialkylammonium⁺, BzNR₃, and dibenzyldiethylammonium⁺.

3. The method of claim 1 for synthesizing zeolite Beta, wherein the organic structure directing agent is selected from hydroxides and halides of the group of TEA, TEA in the presence of diethanoleamine, Dibenzyl-1,4-diazobicyclo[2.2.2.]octane, dibenzyldimethylammonium and benzyldimethylamine+benzylhalide

4. The method of claim 2 wherein up to about 70% of the quaternary ammonium hydroxide is substituted with the halide form.

5. The method of claim 2 wherein up to about 50% of the quaternary ammonium hydroxide is substituted with the halide form.

6. The method of claim 4 wherein the halide form is a bromide.

7. The method of claim 3 wherein up to about 50% of the quaternary ammonium hydroxide is substituted with the halide form.

8. The method of claim 3 wherein up to about 35% of the quaternary ammonium hydroxide is substituted with the halide form.

9. The method of claim 7 wherein the halide form is a bromide.

10. A method of reducing the cost of synthesis of molecular sieve materials from mixtures containing organic structure directing agents having a quaternary ammonium hydroxide group, by substituting an effective amount of a like organic structure directing agent in the quaternary ammonium halide form, for a predetermined fraction (but less than all) of the quaternary ammonium hydroxide.

11. A method for reducing the pressure, without reducing the temperature to below about 125° C., during synthesis of molecular sieve materials from mixtures containing organic structure directing agents having a quaternary ammonium group, wherein the organic structure directing agent comprises a mixture of the hydroxide and halide forms.

12. The method of claim 11 wherein the ratio of halide to hydroxide form is up to about 70:30.

13. The method of claim 11 wherein the ratio of halide to hydroxide form is up to about 50:50.

14. The method of claim 11 wherein the ratio of halide to hydroxide form is up to about 35:65.

15. A method for synthesizing molecular sieve materials at temperatures in excess of about 125° C. using organic structure directing agents having at least one quaternary ammonium hydroxide group, comprising substituting an effective amount of a like organic structure directing agent in the quaternary ammonium halide form, for a predetermined fraction (but less than all) of the quaternary ammonium hydroxide, such that final pressure is substantially reduced, at substantially the same reaction duration, without substantially reducing the reaction temperature.
